(19) United States
(12) Patent Application Publication
(10) Pub. No.: US 2004/0105730 A1
(43) Pub. Date: Jun. 3, 2004

(54) Rotary cutting tool having main body partially coated with hard coating

(75) Inventor: Takayuki Nakajima, Toyokawa-shi (JP)

Correspondence Address: OLIFF & BERRIDGE, PLC, P.O. BOX 19928, ALEXANDRIA, VA, 22320, US

(73) Assignee: OSG CORPORATION, Toyokawa-shi (JP)

(21) Appl. No.: 10/462,762

(22) Filed: Jun. 17, 2003

(30) Foreign Application Priority Data
Nov. 29, 2002 (JP) 2002-347076

(51) Int. Cl. B23B 51/06

(52) U.S. Cl. 408/222

(57) ABSTRACT

A rotary cutting tool including a cylindrical main body which is partially coated with a hard coating, so as to include a coated portion and a non-coated portion that is not coated with the hard coating. The cylindrical main body has: (a) at least one flute each of which extends from an axially distal end of the main body portion to an axially proximal end of the main body portion, and (b) at least one land each of which is provided by a peripheral portion of the cylindrical main body not cut away by the flute or flutes. The coated portion is provided by at least an outer circumferential surface of each land, while the non-coated portion is provided by at least a rear-side portion of a flute surface of each flute as viewed in the predetermined rotating direction.

### BACKGROUND OF THE INVENTION

1. Field of the Invention

This invention relates in general to a rotary cutting tool such as a thread tap, a drill and an end mill, and more particularly to techniques for preventing breakage or chipping of the rotary cutting tool so as to prolong its tool life.

2. Discussion of the Related Art

There is widely known a tap which includes an externally-threaded cylindrical main body having (a) a chamfer portion provided by an axially distal end portion of the cylindrical main body, (b) a full-form thread portion contiguous to the chamfer portion in an axial direction of the cylindrical main body, (c) at least one flute each of which extends from an axially distal end of the cylindrical main body to an axially proximal end of the cylindrical main body, and (d) at least one land each of which is provided by a peripheral portion of the cylindrical main body not cut away by the flute or flutes. As an example of the tap, JP-U-H4-47921 (publication of unexamined Japanese Utility Application laid open in 1992) discloses a tap in which its externally-threaded cylindrical main body is coated with a hard coating in the interest of increasing resistance to wear and fusion and accordingly extending its tool life. There are proposed various types of hard coating to be provided to cover a tool body or substrate. JP-A-H5-57507 (publication of unexamined Japanese Patent Application laid open in 1993) discloses a coated cutting tool in which a tool body or substrate is coated with a hard coating consisting of a layer or layers made of TiN or TiCN.

However, in the conventional coated cutting tool, chips (produced as a result of cutting of a workpiece) are likely to extend long without a sufficient degree of curling, as shown in FIG. 7B, because it is common that the hard coating has a relatively small coefficient of friction. The long extending chips, which are likely to be caught between an outer circumferential surface of the land and a machined surface of the workpiece, tend to cause chipping of a cutting or leading edge or breakage of a body of the cutting tool. This problematic tendency is increased, for example, where a machining (e.g., tapping, drilling, milling) is effected in a workpiece made of a material which inherently produces chips not easily broken into small pieces, or where a tapping operating is effected at a horizontal-type machine in which chips are not easily dropped or removed from the tapped hole because the hole as well as the tap extends in the horizontal direction rather than in the vertical direction.

### SUMMARY OF THE INVENTION

The present invention was made in view of the background prior art discussed above. It is therefore a first object of the present invention to provide a rotary cutting tool having a long tool life without suffering from its breakage due to entry of chips between an outer circumferential surface of the land and a machined surface of the workpiece. This first object may be achieved according to any one of first through seventh aspects of the invention which are described below. It is a second object of the invention to provide a process of manufacturing the rotary cutting tool having the technical advantage as described above. This second object may be achieved according to any one of eighth through twelfth aspects of the invention which are described below.

The first aspect of this invention provides a rotary cutting tool which is to be rotated in a predetermined rotating direction for cutting a workpiece, the rotary cutting tool comprising: a cylindrical main body which is partially coated with a hard coating, so as to include a coated portion and a non-coated portion that is not coated with the hard coating, wherein the cylindrical main body has: at least one flute each of which has a predetermined width and extends from an axially distal end of the main body portion to an axially proximal end of the main body portion, and at least one land each of which is provided by a peripheral portion of the cylindrical main body not cut away by the above-described at least one flute; and wherein the coated portion is provided by at least an outer circumferential surface of each of the above-described at least one land, while the non-coated portion is provided by at least a rear-side portion of a flute surface of each of the above-described at least one flute as viewed in the predetermined rotating direction.

According to the second aspect of the invention, in the rotary cutting tool defined in the first aspect of the invention, the non-coated portion is provided by, in addition to the rear-side portion of the flute surface, a front-side portion of the flute surface as viewed in the predetermined rotating direction, so that the non-coated portion is provided by an entirety of the flute surface.

The third aspect of the invention provides a tap which is to be rotated in a predetermined rotating direction for forming an internal thread in a workpiece, the tap comprising: an externally-threaded cylindrical main body which is partially coated with a hard coating, so as to include a coated portion and a non-coated portion that is not coated with the hard coating, wherein the externally-threaded cylindrical main body has: a chamfer portion provided by an axially distal end portion of the externally-threaded cylindrical main body; a full-form thread portion contiguous to the chamfer portion in an axial direction of the externally-threaded cylindrical main body; at least one flute each of which has a predetermined width and extends from an axially distal end of the externally threaded body to an axially proximal end of the externally-threaded cylindrical main body; at least one land each of which is provided by a peripheral portion of the externally-threaded cylindrical main body not cut away by the above-described at least one flute; and a rake surface which is provided by a rear-side portion of a flute surface of each of the above-described at least one flute as viewed in the predetermined rotating direction; and wherein the coated portion is provided by at least an outer circumferential surface of each of the above-described at least one land, while the non-coated portion is provided by at least a portion of the rake surface which is located in the chamfer portion.

According to the fourth aspect of the invention, in the tap defined in the third aspect of the invention, the non-coated portion is provided by, in addition to the portion of the rake surface which is located in the chamfer portion, a portion of the rake surface which is located in the full-form thread portion.

According to the fifth aspect of the invention, in the tap defined in the third aspect of the invention, the non-coated portion is provided by an entirety of the flute surface of each of the above-described at least one flute.

According to the sixth aspect of the invention, in the tap defined in any one of the third through fifth aspects of the invention, the externally-threaded cylindrical main body is formed of a high speed tool steel, wherein the hard coating is formed of a solid solution including at least one of carbide, nitride and carbon nitride each of which includes at least one of metals which belong to respective groups IIIb, IVa, Va and VIa of the periodic table.

According to the seventh aspect of the invention, in the tap defined in any one of the third through fifth aspects of the invention, the externally-threaded cylindrical main body is formed of a cemented carbide, wherein the hard coating is formed of a solid solution including at least one of carbide, nitride and carbon nitride each of which includes at least one of metals which belong to respective groups IIIb, IVa, Va and VIa of the periodic table.

The eighth aspect of the invention provides a process of manufacturing the rotary cutting tool defined in the second aspect of the invention, the process comprising: a flute forming step of forming the above-described at least one flute in a cylindrical substrate such that the above-described at least one flute has a provisional width that is smaller than the predetermined width; a coating step of coating the cylindrical substrate with the hard coating; and a flute finishing step of finishing the above-described at least one flute, by enlarging the width of each of the above-described at least one flute, such that each of the above-described at least one flute has the predetermined width and such that a portion of the hard coating which covers the flute surface is removed. Where the rotary cutting tool includes, in addition to the cylindrical main body, a cylindrical shank which is formed integrally with the cylindrical main body, the cylindrical shank as well as the cylindrical main body may be provided by the cylindrical substrate. In this case, the cylindrical shank as well as the cylindrical main body may be coated with the hard coating, or alternatively, only the cylindrical main body may be coated with the hard coating without the cylindrical shank being coated with the hard coating.

According to the ninth aspect of the invention, in the process defined in the eighth aspect of the invention the flute forming step and the flute finishing step are implemented in respective grinding operations, wherein the grinding operation of the flute finishing step is effected by using a grinding wheel which is used in the grinding operation of the flute forming step.

The tenth aspect of the invention provides a process of manufacturing the tap defined in the third aspect of the invention, the process comprising: an externally-threaded-body forming step of forming an external thread and the above-described at least one flute in a cylindrical substrate; a coating step of coating the cylindrical substrate with the hard coating; and a coating removing step of removing a portion of the hard coating which covers the non-coated portion provided by at least the portion of the rake surface located in the chamfer portion. Where the tap includes, in addition to the externally-threaded cylindrical main body, a cylindrical shank which is formed integrally with the cylindrical main body, the cylindrical shank as well as the cylindrical main body may be provided by the cylindrical substrate. In this case, the cylindrical shank as well as the cylindrical main body may be coated with the hard coating, or alternatively, only the cylindrical main body may be coated with the hard coating without the cylindrical shank being coated with the hard coating.

The eleventh aspect of the invention provides a process of manufacturing the tap defined in the fifth aspect of the invention, the process comprising: an externally-threaded-body forming step of forming an external thread and the above-described at least one flute in a cylindrical substrate such that the above-described at least one flute has a provisional width that is smaller than the predetermined width; a coating step of coating the cylindrical substrate with the hard coating; and a coating removing step of removing a portion of the hard coating which covers the non-coated portion provided by the entirety of the flute surface of each of the above-described at least one flute, by enlarging the width of each of the above-described at least one flute, such that each of the above-described at least one flute has the predetermined width.

According to the twelfth aspect of the invention, in the process defined in the eleventh aspect of the invention, the coating removing step is implemented in a grinding operation, wherein the grinding operation of the coating removing step is effected by using a grinding wheel which is used for forming the above-described at least one flute in the externally-threaded-body forming step.

In the rotary cutting tool defined in the first or second aspect of the invention in which the cylindrical main body is partially coated with the hard coating, the non-coated portion is provided by at least the rear-side portion of the flute surface as viewed in the predetermined rotating direction. Namely, at least a portion of the hard coating covering the rear-side portion of the flute surface is removed so that a cylindrical tool substrate is exposed at least at the rear-side portion of the flute surface. Therefore, chips produced as a result of cutting of the workpiece are brought into sliding contact with the non-coated rear side portion of the flute surface, and are likely to be sufficiently curled, thereby preventing the chips from being caught between the land and a machined surface of the workpiece, even where the machined workpiece is made of a material which commonly produces chips not easily broken into small pieces. Further, since a cutting or leading edge of the cutting tool (which is provided by a rear-side one of widthwise opposite edges of each of the above-described at least one flute) is sharpen by the removal of the above-described portion of the hard coating covering the rear-side portion of the flute surface, a cutting performance of the cutting tool is further improved.

With the removal of the above-described portion of the hard coating covering the rear-side portion of the flute surface, the rear-side portion of the flute surface might be worn easier than where the entirety of the cylindrical main body is covered with the hard coating. However, it is common that the machining accuracy is affected by wear on the outer circumferential surface of the land, rather than by wear on the rear-side portion of the flute surface. In other words, the wear on the rear-side portion of the flute surface does not seriously affect the tool life (which can be checked with, for example thread plug gauges). In the present rotary cutting tool in which the coated portion is provided by at least the outer circumferential surface of the land, the wear on the land surface is protected by the hard coating, so that the machining accuracy is well maintained during its long tool life.

In the rotary cutting tool defined in the second aspect of the invention, the non-coated portion is provided by the entirety of the flute surface of each of the above-described at least one flute. This rotary cutting tool can be easily manufactured by, for example, the process defined in the eighth aspect of the invention in which the finishing of the flute or flutes and the removal of the portion of the hard coating (covering the flute surface or surfaces) are effected concurrently with each other, whereby the rotary cutting tool can be accurately manufactured with a reduced number of required steps. Further, the removal of the hard coating can be effected in the grinding operation by using the same grinding wheel that is used in the grinding operation of the flute forming step, as in the process defined in the ninth aspect of the invention, whereby the non-coated portion can be reliably established without requiring a tool or device to be used exclusively for the removal of the hard coating.

In the tap defined in any one of the third through seventh aspects of the invention in which the externally-threaded cylindrical main body is partially coated with the hard coating, the non-coated portion is provided by at least the portion of the rake surface which is located in the chamfer portion. Namely, at least the portion of the hard coating covering the portion of the rake surface is removed so that a tool substrate is exposed at least at the portion of the rake surface which is located in the chamfer portion. Therefore, chips produced as a result of cutting of the workpiece are brought into sliding contact with the rake surface in the chamfer portion, and are likely to sufficiently curled, thereby preventing entry of the chips between the land and a machined surface of the workpiece, even where the machined workpiece is made of a material which commonly produces chips not easily broken into small pieces, or where a tapping is effected at a horizontal-type machine in which chips are not easily dropped or removed from the tapped hole because the hole as well as the tap extends in the horizontal direction rather than in the vertical direction. Further, since a cutting edge of the tap (which is provided by a rear-side one of widthwise opposite edges of each of the above-described at least one flute) is sharpen by the removal of the above-described portion of the hard coating covering the portion of the rake surface which is located in the chamfer portion, a cutting performance of the tap is further improved.

With the removal of the above-described portion of the hard coating covering the rake surface in the chamfer portion, the rake surface in the chamfer portion might be worn easier than where the entirety of the externally-threaded cylindrical main body is covered with the hard coating. However, it is common that the machining or threading accuracy is affected by wear on the outer circumferential surface of the land, rather than by wear on the rake surface. In other words, the wear on the rake surface does not seriously affect the tool life. In the present tap in which the coated portion is provided by at least the outer circumferential surface of the land, the wear on the land surface is protected by the hard coating, so that the threading accuracy is well maintained during its long tool life.

In the tap defined in the fifth aspect of the invention, the non-coated portion is provided by the entirety of the flute surface of each of the above-described at least one flute. This tap can be easily manufactured by, for example, the process defined in the eleventh aspect of the invention in which the finishing of the flute or flutes and the removal of the portion of the hard coating (covering the flute surface or surfaces) are effected concurrently with each other, whereby the tap can be accurately manufactured with a reduced number of required steps. Further, the removal of the hard coating can be effected in the grinding operation by using the same grinding wheel that is used in the grinding operation of the externally-threaded-body forming step, as in the process defined in the ninth aspect of the invention, whereby the non-coated portion can be reliably established without requiring a tool or device to be used exclusively for the removal of the hard coating.

The tap defined in any one of the third through seventh aspects of the invention may be a straight thread tap for forming an internal thread having a diameter constant as viewed in the axial direction, or alternatively, may be a tapered thread tap for forming an internal thread having a diameter changed continuously as viewed in the axial direction. Further, the tap of these aspects of the invention may be used to complete a tapping operation. Alternatively, the present tap may serve as one of a set of taps consisting of, for example, a taper tap (No. 1 rougher), a plug tap (No. 2 rougher) and a bottoming tap (No. 3 finisher), which are used in a tapping operation in the order of the description.

In the tap defined in any one of the third through seventh aspects of the invention, the number of the above-described at least one flute (or the number of the above-described at least one land) is preferably three or four, but may be one, two or more than four. Further, each flute may be a straight flute extending in parallel with the axial direction, or alternatively, may be a helical flute extending in a helical direction of the cylindrical main body. In the latter case, it is common that the helical flute is twisted in such a direction that permits the chips accommodated in the flute are displaced toward the axially proximal end portion of the cylindrical main body (i.e., toward a shank of the tap) as the tap is rotated in the predetermined rotating direction. However, the helical flute may be twisted in such a direction that the chips accommodated in the flute are displaced toward the axially distal end portion of the cylindrical main body as the tap is rotated in the predetermined rotating direction, particularly, where the tap is designed to form a thread in a through-hole rather than in a blind hole.

In the tap defined in any one of the third through seventh aspects of the invention, the non-coated portion is provided by at least a portion of the rake surface which is located in the chamfer portion. However, the arrangement of the non-coated portion may be modified as needed. For example, the non-coated portion may be provided by a portion of the rake surface which is located radially outside the root of the external thread (that is located on the minor diameter of the external thread). Further, a portion of the rake surface close to the cutting edge may be coated with the hard coating, so that the non-coated portion is provided by the rake surface except this portion close to the cutting edge.

The tool substrate providing the cylindrical main body of the rotary cutting tool or the tap is preferably formed of cemented carbide or high speed tool steel. However, the tool substrate may be formed of any other kind of material such as a hard tool material other than the cemented carbide.

The hard coating is preferably made of a solid solution including at least one of carbide, nitride and carbon nitride each of which includes at least one of metals belonging to respective groups IIIb, IVa, Va and VIa of the periodic table. The metal belonging to the group IIIb, IVa, Va or VIa may be, for example, Al, Ti, V or Cr. The solid solution may be, for example, TiAlN, TiCN, TiCrN or TiN. The hard coating may be provided by either a single layer or a plurality of layers. While the hard coating is preferably formed, in accordance with a PVD method such as arc ion plating method and sputtering method, the hard coating may be formed in accordance with a plasma CVD method or any other method.

The removal of the selected portion of the hard coating is effected preferably in a grinding operation in which a grinding wheel is used, for example, where the hard coating is formed of TiAlN, TiCN, TiCrN or TiN. However, the removal of the hard coating may be effected in another suitable manner, depending upon the kind of material forming the hard coating.

In the rotary-cutting-tool manufacturing process defined in the ninth aspect of the invention, the grinding operation of the flute finishing step is effected by using the grinding wheel which is used in the grinding operation of the flute forming step, such that the grinding wheel is given a larger depth of cut in the flute finishing step than in the flute forming step, whereby the width of the flute formed in the flute forming step is enlarged to have the predetermined value in the flute finishing step. However, the grinding operations of the flute forming step and the flute finishing step do not have to be effected necessarily by using the same grinding wheel, but may be effected by using respective grinding wheels different from each other.

In the tap manufacturing process defined in the eleventh aspect of the invention, the formation of the above-described at least one flute in the externally-threaded-body forming step is effected such that the flute has the provisional width smaller than the above-described predetermined width. However, in the tap manufacturing process defined in the tenth aspect of the invention, the formation of the above-described at least one flute in the externally-threaded-body forming step may be effected by a grinding operation such that the flute has the predetermined width, so that the removal of the above-described portion of the hard coating in the coating removing step can be effected by the same grinding operation with the same depth of cut. In this case, the portion of the hard coating is intended to be removed without enlarging the width or depth of the flute formed in the externally-threaded-body forming step. In this instance, all the portion of the hard coating does not have to be necessarily removed from the cylindrical substrate, but the portion of the hard coating may be partially left unremoved from the cylindrical substrate.

In the tap manufacturing process defined in the twelfth aspect of the invention, the grinding operation of the coating removing step is effected by using the grinding wheel which is used in the grinding operation of the externally-threaded-body forming step, such that the grinding wheel is given a larger depth of cut in the coating removing step than in the externally-threaded-body forming step, whereby the width of the flute formed in the externally-threaded-body forming step is enlarged to have the predetermined value in the coating removing step. However, the grinding operations of the externally-threaded-body forming step and the coating removing step do not have to be effected necessarily by using the same grinding wheel, but may be effected by using respective grinding wheels different from each other.

### BRIEF DESCRIPTION OF THE DRAWINGS

The above and other objects, features, advantages and technical and industrial significance of this invention will be better understood by reading the following detailed description of the presently preferred embodiments of the invention, when considered in connection with the accompanying drawings, in which:

FIG. 1A is a view of a straight thread tap constructed according to an embodiment of the invention, as viewed in a direction perpendicular to an axis of the tool;

FIG. 1B is a bottom view of the tap of FIG. 1A;

FIG. 1C is a fragmentary view in transverse cross section of a chamfer portion of the tap of FIG. 1A;

FIG. 2 is a fragmentary view of a rake surface in the chamfer portion of the tap of FIG. 1A;

FIG. 3 is a fragmentary view of the rake surface in a full-form thread portion of the tap of FIG. 1A;

FIG. 4 is a flow chart showing a process of manufacturing the tap of FIG. 1A;

FIG. 5 is a view schematically illustrating a grinding operation in a coating removing step of the manufacturing process of FIG. 4;

FIG. 6 is a fragmentary view in transverse cross section of the chamfer portion of the tap which is coated at the entirety of its externally-threaded cylindrical main body with a hard coating before implementation of the coating removing step of the process of FIG. 4;

FIG. 7A is a view showing chips produced in a tapping operation with the tap of FIG. 1A;

FIG. 7B is a view showing chips produced in a tapping operation with a conventional tap in which the flute surfaces as well as the other portions of its cylindrical main body are coated with the hard coating;

FIG. 8 is a graph indicating a result of a test in which tapping operations were made by using the tap of FIG. 1A, a conventional coated tap and a conventional non-coated tap, for measuring a durability of each tap; and

FIG. 9 is a fragmentary view in transverse cross section of a chamfer portion of a tap constructed according, to another embodiment of the invention.

### DETAILED DESCRIPTION OF THE PREFERRED EMBODIMENTS

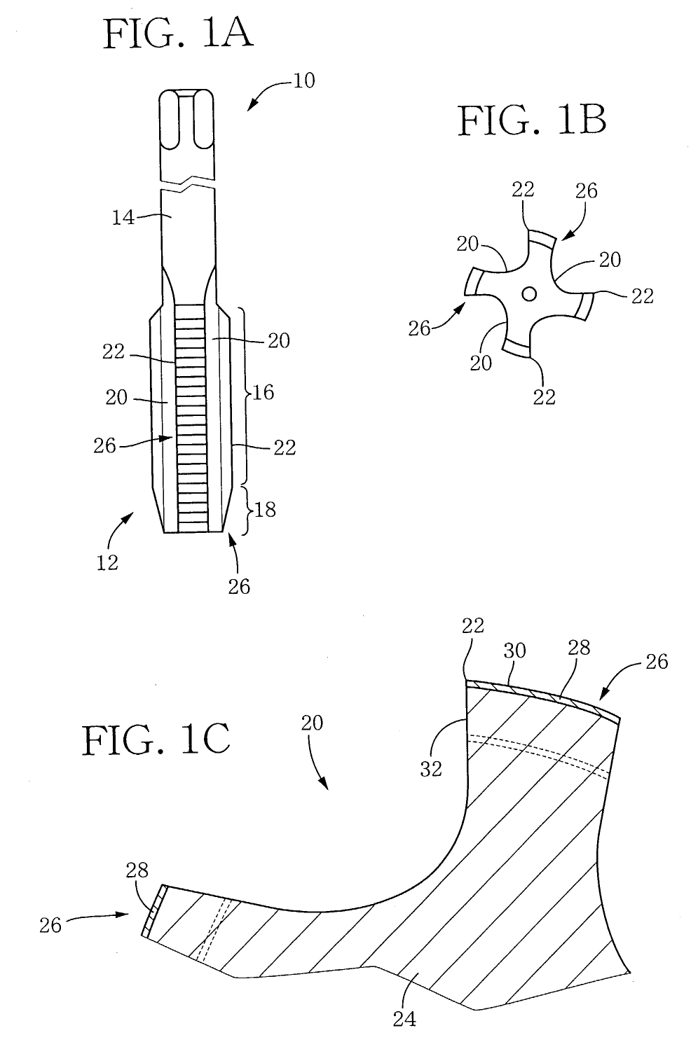

FIGS. 1A-1C show a rotary cutting tool in the form of a four-fluted straight-thread hand tap 10 which is constructed according to an embodiment of this invention. The tap 10 consists of an externally-threaded cylindrical main body 12 and a cylindrical shank 14 which are coaxial with each other and which are formed integrally with each other. The tap 10 is designed to form a right-hand internal thread in a workpiece, and has a right-hand external thread formed in an outer circumferential surface of the externally-threaded cylindrical main body 12. The cylindrical main body 12 has four flutes 20 each of which has a predetermined width and extends in parallel with an axis of the cylindrical main body 12, and four lands 26 each of which is provided by a peripheral portion of the cylindrical main body 12 not cut away by the four flutes 20. An axially distal end portion of the externally-threaded cylindrical main body 12 provides a chamfer portion 18 which is tapered such that its diameter is reduced as viewed in a direction toward an axially distal end of the cylindrical main body 12 away from an axially proximal end of the cylindrical main body 12. A full-form thread portion 16, in which a height of thread is constant, is provided by axially intermediate and proximal end portions of the cylindrical main body 12 and is contiguous to the chamfer portion 18 in the axial direction.

In a tapping operation with this tap 10, the tap 10 is held at its shank 14 by a machine through a suitable holder. The tap 10 is then moved or fed toward a hole prepared in the workpiece at a feed rate which corresponds to a pitch or lead of the internal thread to be formed in the hole, while being rotated about its axis in a predetermined rotating direction, so that the internal thread is formed in an inner circumferential surface of the hole, by cutting with four cutting edges 22 each of which is provided by a rear-side one of widthwise opposite edges of the corresponding flute 20 as viewed in the predetermined rotating direction.

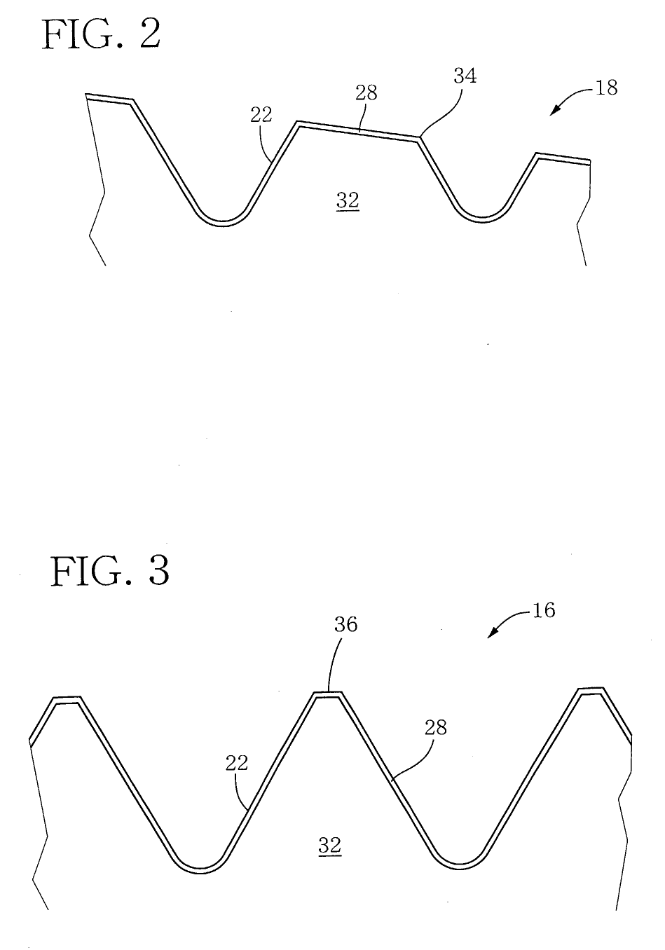

The tap 10 consisting of the externally-threaded cylindrical main body 12 and the cylindrical shank 14 is provided by a cylindrical substrate 24 which is formed of a cemented carbide. The cylindrical main body 12 is partially coated with a hard coating 28 formed of TiCN alloy, so as to include a coated portion and a non-coated portion that is not coated with the hard coating 28. In the present embodiment, the coated portion is constituted by a relief surface 30, i.e., an outer circumferential surface of each of the lands 26, while the non-coated portion is constituted by a flute surface (i.e., concaved surface) of each of the flutes 20. The hard coating 28 covering the relief surface 30 of each land 26 has a predetermined thickness which is constant over the entirety of the relief surface 30 so that a corrugated shape of the external thread is not affected by the hard coating 28, as shown in FIGS. 2 and 3. The cylindrical substrate 24 is exposed at the non-coated portion, i.e., at the entirety of the flute surface of each flute 20. It is noted that a rake surface 32 is provided by a rear-side portion of the non-coated flute surface as viewed in the predetermined rotating direction.

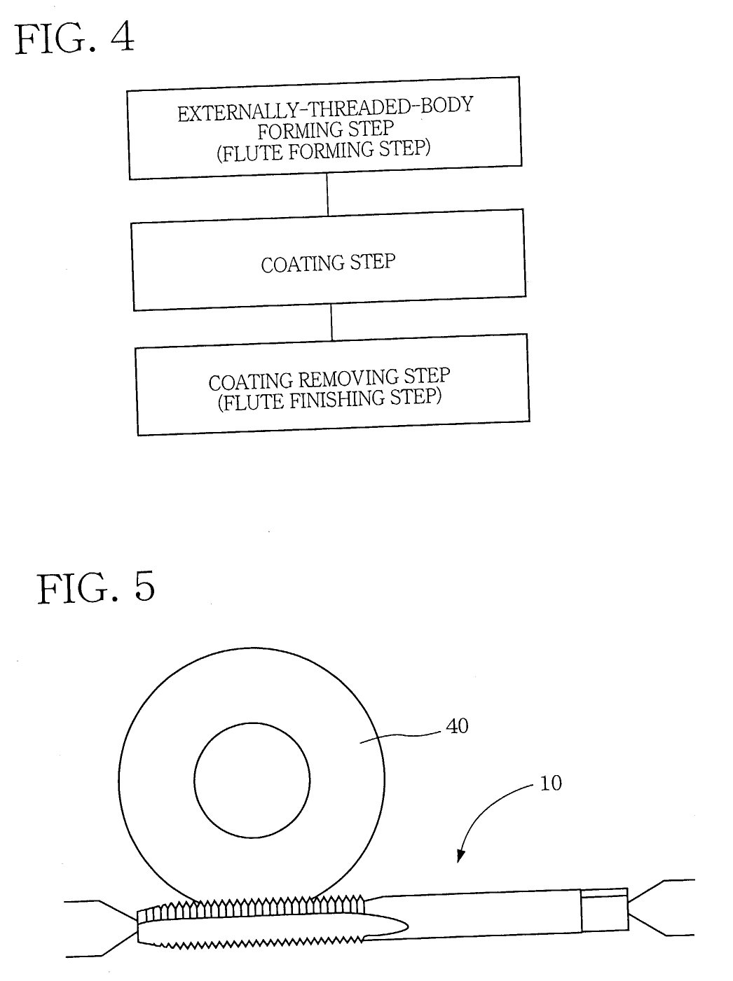

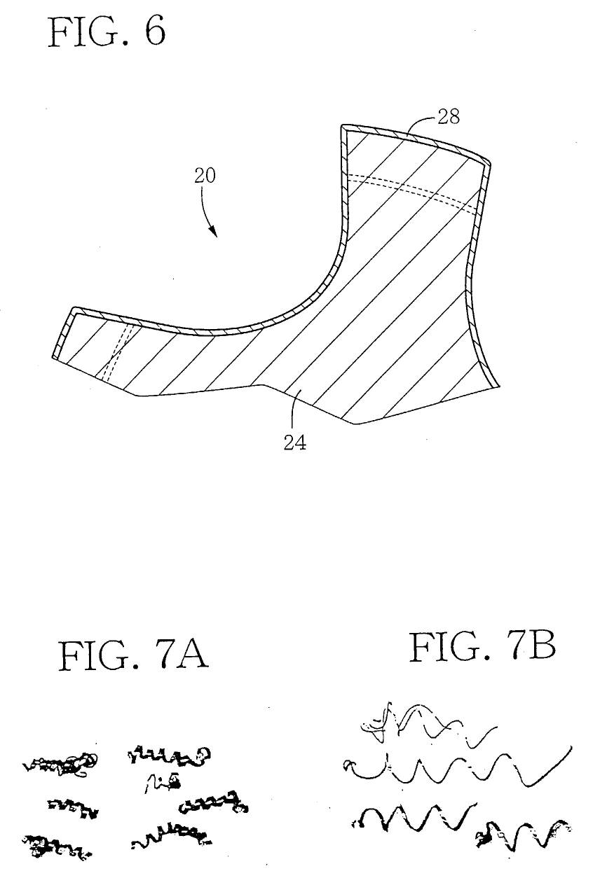

FIG. 4 is a flow chart showing a process of manufacturing the tap 10. The process is initiated with an externally-threaded-body forming step which is implemented to form the external thread and the four flutes 20 in the cylindrical substrate 24, for example, in grinding operations. In this step, each of the four flutes 20 is formed to have a provisional width that is slightly smaller than the above-described predetermined width. The externally-threaded-body forming step is followed by a coating step in which the cylindrical main body 12 is fully coated with the hard coating 28 in accordance with a PVD method such as arc ion plating method and sputtering method, such that the hard coating 28 having an uniform thickness not larger than 10 μm is deposited on an entire surface of the cylindrical main body 12. That is, in this coating step, not only the relief surface 30 of each land 26 but also the flute surface of each flute 20 is coated with the hard coating 28, as shown in FIG. 6.

A coating removing step is then implemented to remove portions of the hard coating 28 which cover the flute surfaces of the respective flutes 20, by enlarging the width of each of the flutes 20 such that each flute 20 has the above-described predetermined width. With the removal of the above-described portions of the hard coating 28, the cylindrical substrate 24 is exposed at the flute surfaces of the flutes 20. The coating removing step is effected in a grinding operation, as shown in FIG. 5. This grinding operation of the coating removing step can be carried out by using a grinding wheel 40 which was used also for forming the flutes 20 in the externally-threaded-body forming step. The grinding wheel 40 is given a larger depth of cut in the coating removing step than in the externally-threaded-body forming step. That is, the grinding wheel 40 is positioned closer to the axis of the cylindrical substrate 24 in the coating removing step than in the externally-threaded-body forming step, such that each flute 20 becomes to have the predetermined width and such that the portion of the hard coating 28 covering the flute surface of each flute 20 is removed, whereby the tap 10 as shown in FIGS. 1A-C is obtained. It is noted that the externally-threaded-body forming step and the coating removing step may be referred also to as a flute forming step and a flute finishing step, respectively.

As described above, in the tap 10 constructed according to the present embodiment of the invention, the portions of the hard coating 28 covering the flute surfaces (including the rake surfaces 32) of the flutes 20 are removed so that the cylindrical substrate 24 is exposed at the flute surfaces. Therefore, chips produced as a result of cutting of the workpiece are brought into sliding contact with the rake surfaces 32 not coated with the hard coating 28, and are likely to be sufficiently curled as shown in FIG. 7A, thereby preventing the chips from being caught between the relief surface 30 of each land 26 and the threaded surface of the hole, even where the workpiece is made of a material which commonly produces chips not easily broken into small pieces, or where a tapping operation is effected at a horizontal-type machine in which chips are not easily dropped or removed from the tapped hole because the hole as well as the tap extends in the horizontal direction rather than in the vertical direction. Owing to the effective prevention of entry of the chips between the relief surface 30 and the machined surface of the hole, it is possible to remarkably reduce a risk of brakeage or chipping of the tool. It is noted that FIG. 7B shows chips produced in a tapping operation with a conventional tap in which the flute surfaces as well as the other portions of its cylindrical main body are coated with the hard coating. The chips produced in the tapping operation with the conventional tap tend to have larger lengths with a smaller degree of curling, as shown in FIG. 7B, than in the tapping operation with the tap 10 of the present invention wherein the chips are made comparatively short with a larger degree of curling, as shown in FIG. 7A.

Further, with the removal of the above-described portions of the hard coating 28 which have covered the flute surfaces, it is possible to sharpen the cutting edges 22 each located at the intersection of the rake surface 32 and the relief surface 30, thereby further improving a cutting performance of the tap 10.

With the removal of the above-described portions of the hard coating 28 which have covered the flute surfaces, the rake surfaces 32 (included in the respective flute surfaces) might be easily worn. However, it is common that the machining performance and the machining accuracy (which can be checked with, for example, thread plug gauges) are affected by wear on the relief surfaces 30 of the lands 26, rather than by wear on the rake surfaces 32. In other words, the wear on the rake surfaces 32 does not seriously affect the tool life. The machining performance is deteriorated, particularly, where each relief surface 30 is worn at its portions located behind radially outer ends 34 of respective flanks in the chamfer portion 18. The machining accuracy is deteriorated, particularly, where each relief surface 30 is worn at its portions located behind crests 36 of the respective threads in the full-form thread portion 16. In the tap 10 in which the coated portion is provided by each relief surface 30, the wear on the relief surface 30 is protected by the hard coating 28, so that the machining performance and accuracy are well maintained during its prolonged tool life.

As described above, the tap 10 can be manufactured in accordance with the process including: the externally-threaded-body forming step in which the flutes 20 are formed on the externally-threaded cylindrical main body 12 such that each flute 20 has the provisional width smaller than the predetermined width; the coating step in which the externally-threaded cylindrical main body 12 is coated with the hard coating 28; and the coating removing step in which the portions of the hard coating 28 covering the flute surfaces are removed by enlarging the width of each flute 20 to the predetermined width. Since the finishing of each flute 20 and the removal of the portions of the hard coating 28 are effected concurrently with each other, whereby the tap 10 can be accurately manufactured with a reduced number of required steps. Further, the removal of the hard coating 28 is effected in the grinding operation by using the same grinding wheel 40 that is used in the grinding operation of the externally-threaded-body forming step, whereby the non-coated portion can be reliably established without requiring a tool or device to be used exclusively for the removal of the hard coating 28.

A test was conducted by using the tap 10 (of the present invention), a conventional coated tap (in which the flute surfaces as well as the other portions of its externally-threaded cylindrical main body are coated with the hard coating 28) and a conventional non-coated tap (in which its externally-threaded cylindrical main body is not coated with the hard coating 28 at all). The used three taps are identical in dimensions, and have a nominal size of M10×1.0, a core diameter of about 4.8 mm, a rake angle of 0° (i.e., zero rake in which each rake surface 32 is directly on a radial line) and a margin width of substantially zero. In the test, internal threads were successively formed in prepared holes under a cutting condition as specified below, for checking durability of each tap by seeing the number of the holes tapped successively without intolerable deterioration in the machining accuracy or without breakage of the tap.

[Cutting Condition]

Workpiece: S45C (Carbon steel for machine structural use)

Cutting velocity: 5.97 m/min (190 min⁻¹)

Feed rate: 190 mm/min (1.0 mm/rev)

Size of prepared hole: Φ8.5×23 (blind hole)

Tapping length: 15 mm

Cutting fluid: Water soluble fluid

Used machine: Horizontal-type machining center

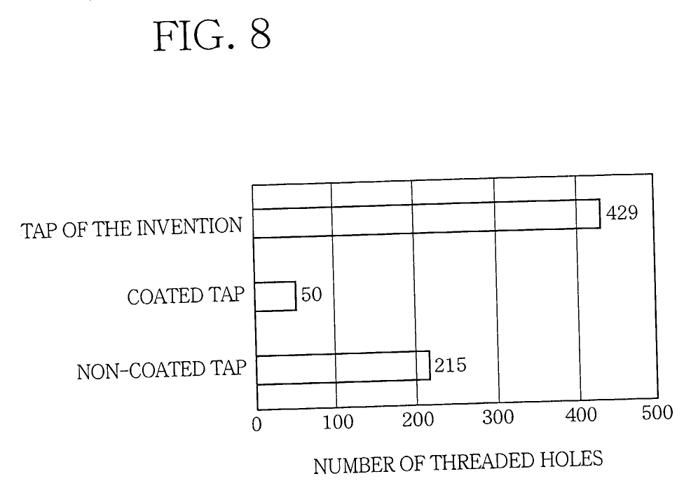

FIG. 8 shows the result of the test, namely, an average value of the number of the holes which could be successively tapped by each of the three taps. As shown in FIG. 8, the number (429) of the holes tapped by the tap 10 of the invention is about twice the number (215) of the holes tapped by the conventional non-coated tap. In the successive tapping operations with the tap 10, the 429th tapped hole was the last tapped hole which could introduce therein the “go” end of thread plug gauges and was determined to be within a predetermined tolerance. In the successive tapping operations with the conventional non-coated tap, the 215th tapped hole was the last tapped hole which could introduce therein the “go” end of the thread plug gauges and was determined to be within the predetermined tolerance. That is, the tool life of each of the tap 10 and the non-coated tool was finished due to wear on its relief surfaces. It can be considered that the remarkably prolonged tool life of the tap 10 was owing to the hard coating 28 covering the relief surfaces 30.

The number of the holes tapped by the conventional coated tap was so small as 50. The tool life of the conventional coated tap was finished due to its tool breakage that was occurred when the 51st hole was being tapped with the coated tap. It is considered that the tool breakage was occurred due to relatively long extended shapes of the chips, as shown in FIG. 7B, which were produced during the tapping operations with the conventional coated tap.

While one embodiment of the present invention has been described in detail for illustrative purpose only, it is to be understood that the invention is not limited to the above embodiment but may be otherwise embodied.

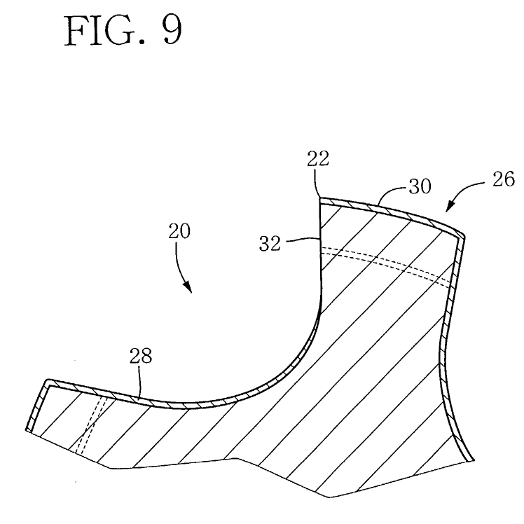

For example, while the non-coated portion is provided by the entirety of the flute surface of each flute 20 in the above-described embodiment, the non-coated portion may be provided by only the rake surfaces 32 each of which corresponds to the rear-side portion of the flute surface of each flute 20 as viewed in the predetermined rotating direction, as shown in FIG. 9. In this another embodiment shown in FIG. 9, the non-coated portion may be provided only a portion of each rake surface 32 that is located in the chamfer portion 18, or alternatively, may be provided by, in addition to the portion of each rake surface 32 that is located in the chamfer portion 18, a portion of each rake surface 32 that is located in the full-form thread portion 16. In the latter case, the non-coated portion is provided by the entirety of each rake surface 32.

Further, the principle of the invention is applicable not only to a straight thread tap as the above-described tap 10 but also a tapered thread tap and other kind of rotary cutting tool such as a drill, an end mill and a reamer.

While the presently preferred embodiments of the present invention have been illustrated above, it is to be understood that the invention is not limited to the details of the illustrated embodiments, but may be embodied with various other changes, modifications and improvements, which may occur to those skilled in the art, without departing from the spirit and scope of the invention defined in the following claims.

What is claimed is:

1. A rotary cutting tool which is to be rotated in a predetermined rotating direction for cutting a workpiece, said rotary cutting tool comprising:
a cylindrical main body which is partially coated with a hard coating, so as to include a coated portion and a non-coated portion that is not coated with said hard coating,
wherein said cylindrical main body has:
at least one flute each of which has a predetermined width and extends from an axially distal end of said main body portion to an axially proximal end of said main body portion, and
at least one land each of which is provided by a peripheral portion of said cylindrical main body not cut away by said at least one flute;
and wherein said coated portion is provided by at least an outer circumferential surface of each of said at least one land, while said non-coated portion is provided by at least a rear-side portion of a flute surface of each of said at least one flute as viewed in said predetermined rotating direction.

2. A rotary cutting tool according to claim 1, wherein said non-coated portion is provided by, in addition to said rear-side portion of said flute surface, a front-side portion of said flute surface as viewed in said predetermined rotating direction, so that said non-coated portion is provided by an entirety of said flute surface.

3. A tap which is to be rotated in a predetermined rotating direction for forming an internal thread in a workpiece, said tap comprising:
an externally-threaded cylindrical main body which is partially coated with a hard coating, so as to include a coated portion and a non-coated portion that is not coated with said hard coating,
wherein said externally-threaded cylindrical main body has:
a chamfer portion provided by an axially distal end portion of said externally-threaded cylindrical main body;
a full-form thread portion contiguous to said chamfer portion in an axial direction of said externally-threaded cylindrical main body;
at least one flute each of which has a predetermined width and extends from an axially distal end of said externally threaded body to an axially proximal end of said externally-threaded cylindrical main body;
at least one land each of which is provided by a peripheral portion of said externally-threaded cylindrical main body not cut away by said at least one flute; and
a rake surface which is provided by a rear-side portion of a flute surface of each of said at least one flute as viewed in said predetermined rotating direction;
and wherein said coated portion is provided by at least an outer circumferential surface of each of said at least one land, while said non-coated portion is provided by at least a portion of said rake surface which is located in said chamfer portion.

4. A tap according to claim 3, wherein said non-coated portion is provided by, in addition to said portion of said rake surface which is located in said chamfer portion, a portion of said rake surface which is located in said full-form thread portion.

5. A tap according to claim 3, wherein said non-coated portion is provided by an entirety of said flute surface of each of said at least one flute.

6. A tap according to claim 3,
wherein said externally-threaded cylindrical main body is formed of a high speed tool steel,
and wherein said hard coating is formed of a solid solution including at least one of carbide, nitride and carbon nitride each of which includes at least one of metals which belong to respective groups IIIb, IVa, Va and VIa of the periodic table.

7. A tap according to claim 3,
wherein said externally-threaded cylindrical main body is formed of a cemented carbide,
and wherein said hard coating is formed of a solid solution including at least one of carbide, nitride and carbon nitride each of which includes at least one of metals which belong to respective groups IIIb, IVa, Va and VIa of the periodic table.

8. A process of manufacturing the rotary cutting tool defined in claim 2, said process comprising:
a flute forming step of forming said at least one flute in a cylindrical substrate such that said at least one flute has a provisional width that is smaller than said predetermined width;
a coating step of coating said cylindrical substrate with said hard coating; and
a flute finishing step of finishing said at least one flute, by enlarging the width of each of said at least one flute, such that each of said at least one flute has said predetermined width and such that a portion of said hard coating which covers said flute surface is removed.

9. A process according to claim 8,
wherein said flute forming step and said flute finishing step are implemented in respective grinding operations,
and wherein the grinding operation of said flute finishing step is effected by using a grinding wheel which is used in the grinding operation of said flute forming step.

10. A process of manufacturing the tap defined in claim 3, said process comprising:
an externally-threaded-body forming step of forming an external thread and said at least one flute in a cylindrical substrate;
a coating step of coating said cylindrical substrate with said hard coating; and
a coating removing step of removing a portion of said hard coating which covers said non-coated portion provided by at least said portion of said rake surface located in said chamfer portion.

11. A process of manufacturing the tap defined in claim 5, said process comprising:
an externally-threaded-body forming step of forming an external thread and said at least one flute in a cylindrical substrate such that said at least one flute has a provisional width that is smaller than said predetermined width;
a coating step of coating said cylindrical substrate with said hard coating; and.
a coating removing step of removing a portion of said hard coating which covers said non-coated portion provided by the entirety of said flute surface of each of said at least one flute, by enlarging the width of each of said at least one flute, such that each of said at least one flute has said predetermined width.

12. A process according to claim 11,
wherein said coating removing step is implemented in a grinding operation,
and wherein the grinding operation of said coating removing step is effected by using a grinding wheel which is used for forming said at least one flute in said externally-threaded-body forming step.
